(19) United States
(12) Patent Application Publication
(10) Pub. No.: US 2015/0016113 A1
(43) Pub. Date: Jan. 15, 2015

(54) Methods of Changing an Appearance of an Illumination Apparatus String, Cover Apparatuses, Uses of Same, and Kits and Assemblies Comprising Same

(71) Applicant: Kazager L.E.D. Components Inc., Port Coquitlam (CA)

(72) Inventor: Steven Scott Kazemir, Port Coquitlam (CA)

(73) Assignee: Kazager L.E.D. Components Inc., Port Coquitlam (CA)

(21) Appl. No.: 14/380,367

(22) PCT Filed: Feb. 21, 2013
(86) PCT No.: PCT/CA2013/000164

§ 371 Date: Aug. 21, 2014

Related U.S. Application Data
(60) Provisional application No. 61/633,800, filed on Feb. 21, 2012.

(51) Int. Cl. F21V 3/00; F21K 99/00; F21S 4/00

(52) U.S. Cl. CPC F21V 3/00; F21S 4/001; F21K 9/10; F21Y 2101/02
USPC 362/249.06; 362/249.14

(57) ABSTRACT

According to one illustrative embodiment, there is provided a method of changing an appearance of an illumination apparatus string, the method involving: detachably coupling a cover body to one of a plurality of illumination apparatuses on the illumination apparatus string such that an illuminatable portion of the one of the plurality of illumination apparatuses is received in a receptacle defined by the cover body. According to another illustrative embodiment, there is provided a cover apparatus including: a cover body defining a receptacle and configured to be detachably coupled to one of a plurality of illumination apparatuses on an illumination apparatus string such that an illuminatable portion of the one of the illumination apparatuses is received in the receptacle when the cover body is detachably coupled to the one of the illumination apparatuses. Uses of the apparatus, and kits and assemblies including the apparatus, are also disclosed.

### CROSS-REFERENCE TO RELATED APPLICATION

This application claims the benefit of, and priority to, United States provisional patent application No. 61/633,800 filed on Feb. 21, 2012, the entire contents of which are incorporated by reference herein.

### BACKGROUND

1. Field

This disclosure relates generally to appearances of illumination apparatus strings, and more particularly to methods of changing an appearance of an illumination apparatus string, cover apparatuses, uses of the cover apparatuses, and kits and assemblies comprising the cover apparatuses.

2. Related Art

Decorative lighting may be used on many occasions, such as for Christmas but also on numerous other occasions. Often, decorative lighting is commercially available on strings, such as strings of incandescent light bulbs for example. In many commercially available strings of incandescent light bulbs, each incandescent light bulb can be individually connected to and removed from a respective socket of the string, thereby permitting colours and other characteristics of each individual light bulb to be varied. However, incandescent light bulbs have become less popular, for example because of high energy consumption, hazards that can arise because of heat emitted from filaments in incandescent light bulbs, and limited usable life of incandescent light bulbs.

One alternative to a string of incandescent light bulbs is a string of light-emitting diodes (“LEDs”) because LEDs can last longer than incandescent light bulbs and can emit light more efficiently than incandescent light bulbs without generating as much heat as incandescent light bulbs. However, commercially available strings of LEDs are generally less adaptable than strings of incandescent light bulbs because individual LEDs cannot be connected to or removed from respective sockets of the string. Commercially available strings of LEDs generally have fixed colours and appearances, and therefore have a generally uniform and constant appearance. Even LED strings with differently coloured LEDs still have fixed colours, and therefore have a generally constant appearance.

### SUMMARY

According to one illustrative embodiment, there is provided a method of changing an appearance of an illumination apparatus string. The method involves detachably coupling a cover body to one of a plurality of illumination apparatuses on the illumination apparatus string such that an illuminatable portion of the one of the plurality of illumination apparatuses is received in a receptacle defined by the cover body.

The illuminatable portion of the one of the plurality of illumination apparatuses may include a light-emitting diode (“LED”).

Detachably coupling the cover body to the one of the plurality of illumination apparatuses may involve detachably coupling the cover body to a refractive cover of the illuminatable portion of the one of the plurality of illumination apparatuses.

The cover body may include an opaque portion positioned to block light emitted from the illuminatable portion of the one of the illumination apparatuses when the illuminatable portion of the one of the illumination apparatuses is received in the receptacle.

The cover body may include a translucent portion positioned to transmit at least some light emitted from the illuminatable portion of the one of the illumination apparatuses when the illuminatable portion of the one of the illumination apparatuses is received in the receptacle.

The cover body may include: at least one opaque portion positioned to block light emitted from the illuminatable portion of the one of the illumination apparatuses when the illuminatable portion of the one of the illumination apparatuses is received in the receptacle; and at least one translucent portion positioned to transmit at least some of the light emitted from the illuminatable portion of the one of the illumination apparatuses when the illuminatable portion of the one of the illumination apparatuses is received in the receptacle.

Detachably coupling the cover body to the one of the plurality of illumination apparatuses may involve resiliently deforming at least a portion of the cover body.

Resiliently deforming at least a portion of the cover body may involve resiliently deforming an end portion of the cover body adjacent an opening to the receptacle to widen the opening to the receptacle resiliently to a width at least as wide as a maximum width of the illuminatable portion of the one of the illumination apparatuses.

Resiliently deforming the end portion of the cover body may involve causing the end portion of the cover body to be retained on a retaining portion of an outer surface of the illuminatable portion of the one of the illumination apparatuses. The retaining portion may have a width less than the maximum width of the illuminatable portion of the one of the illumination apparatuses.

Resiliently deforming the end portion of the cover body may involve stretching the end portion of the cover body to the width at least as wide as the maximum width of the illuminatable portion of the one of the illumination apparatuses.

Detachably coupling the cover body to the one of the plurality of illumination apparatuses may involve unrolling a rolled portion of the cover body.

Resiliently deforming the end portion of the cover body may involve widening at least one longitudinal gap between projections on the end portion of the cover body and surrounding the opening to the receptacle.

The cover body may be unitary.

Detachably coupling the cover body to the one of the plurality of illumination apparatuses may involve detachably coupling a first lateral portion of the cover body to a second lateral portion of the cover body.

Detachably coupling the first lateral portion of the cover body to the second lateral portion of the cover body may involve resiliently deforming at least a portion of at least one of the first and second lateral portions of the cover body to position a first retaining surface on the first lateral portion of the cover body in contact with a second retaining surface on the second lateral portion of the cover body to couple the first lateral portion of the cover body detachably to the second lateral portion of the cover body.

According to another illustrative embodiment, there is provided a cover apparatus. The apparatus includes a cover body defining a receptacle and configured to be detachably coupled to one of a plurality of illumination apparatuses on an illumination apparatus string such that an illuminatable portion of the one of the illumination apparatuses is received in the receptacle when the cover body is detachably coupled to the one of the illumination apparatuses.

The illuminatable portion of the one of the plurality of illumination apparatuses may include a light-emitting diode (“LED”).

The cover body may be configured to be detachably coupled to a refractive cover of the illuminatable portion of the one of the plurality of illumination apparatuses.

The cover body may include an opaque portion positioned to block light emitted from the illuminatable portion of the one of the illumination apparatuses when the illuminatable portion of the one of the illumination apparatuses is received in the receptacle.

The cover body may include a translucent portion positioned to transmit at least some light emitted from the illuminatable portion of the one of the illumination apparatuses when the illuminatable portion of the one of the illumination apparatuses is received in the receptacle.

The cover body may include: at least one opaque portion positioned to block light emitted from the illuminatable portion of the one of the illumination apparatuses when the illuminatable portion of the one of the illumination apparatuses is received in the receptacle; and at least one translucent portion positioned to transmit at least some of the light emitted from the illuminatable portion of the one of the illumination apparatuses when the illuminatable portion of the one of the illumination apparatuses is received in the receptacle.

At least a portion of the cover body may be resiliently deformable to facilitate detachably coupling the cover body to the one of the plurality of illumination apparatuses.

The cover body may define an opening to the receptacle. The cover body may include an end portion adjacent the opening to the receptacle. The end portion may be resiliently deformable to widen the opening to the receptacle resiliently to a width at least as wide as a maximum width of the illuminatable portion of the one of the illumination apparatuses.

The end portion of the cover body may be configured to be retained on a retaining portion of an outer surface of the illuminatable portion of the one of the illumination apparatuses. The retaining surface may have a width less than the maximum width of the illuminatable portion of the one of the illumination apparatuses.

The end portion of the cover body may be stretchable to the width at least as wide as the maximum width of the illuminatable portion of the one of the illumination apparatuses.

A portion of the cover body may be configured to be unrolled to facilitate detachably coupling the cover body to the one of the plurality of illumination apparatuses.

The end portion of the cover body may include a plurality of projections surrounding the opening to the receptacle. The plurality of projections may be resiliently deflectable to widen the opening to the receptacle resiliently to the width at least as wide as the maximum width of the illuminatable portion of the one of the illumination apparatuses.

The cover body may be unitary.

The cover body may include first and second lateral portions. The first lateral portion of the cover body may be configured to be detachably coupled to the second lateral portion of the cover body to couple the cover body detachably to the one of the plurality of illumination apparatuses.

The first lateral portion of the cover body may define a first retaining surface. The second lateral portion of the cover body may define a second retaining surface. At least a portion of at least one of the first and second lateral portions of the cover body may be configured to be resiliently deformed to position the first retaining surface in contact with the second retaining surface to couple the first lateral portion of the cover body detachably to the second lateral portion of the cover body.

According to another illustrative embodiment, there is provided use of the apparatus to change an appearance of the illumination apparatus string.

According to another illustrative embodiment, there is provided a kit including a plurality of the apparatuses.

According to another illustrative embodiment, there is provided a kit including: the apparatus; and the illumination apparatus string.

According to another illustrative embodiment, there is provided a kit including: a plurality of the apparatuses; and the illumination apparatus string.

According to another illustrative embodiment, there is provided an illumination apparatus string assembly including: the apparatus; and the illumination apparatus string; wherein the cover body is detachably coupled to the one of the plurality of illumination apparatuses such that the illuminatable portion of the one of the illumination apparatuses is received in the receptacle.

Other aspects and features will become apparent to those ordinarily skilled in the art upon review of the following description of illustrative embodiments of the invention in conjunction with the accompanying figures.

### BRIEF DESCRIPTION OF THE DRAWINGS

In drawings of illustrative embodiments:

FIG. 1 is an elevational view of an illumination apparatus string according to an illustrative embodiment;

FIG. 2 is a bottom perspective view of a cover apparatus of the illumination apparatus string of FIG. 1;

FIG. 3 is a cross-sectional view of the cover apparatus of FIG. 2, taken along the line III-Ill in FIG. 2;

FIG. 4 is a disassembled elevational view of an illumination apparatus assembly including an illumination apparatus of the illumination apparatus string of FIG. 1 and the cover apparatus of FIG. 2;

FIG. 5 is a partially assembled elevational view of the illumination apparatus assembly of FIG. 4;

FIG. 6 is a bottom perspective view of another cover apparatus of the illumination apparatus string of FIG. 1;

FIG. 7 is a bottom plan view of the cover apparatus of FIG. 6;

FIG. 8 is a disassembled elevational view of another illumination apparatus assembly including another illumination apparatus of the illumination apparatus string of FIG. 1 and the cover apparatus of FIG. 6;

FIG. 9 is a partially assembled elevational view of the illumination apparatus assembly of FIG. 8;

FIG. 10 is a top perspective view of a lateral portion of another cover apparatus of the illumination apparatus string of FIG. 1;

FIG. 11 is a cross-sectional view of the lateral portion of FIG. 10, taken along the line XI-XI in FIG. 10;

FIG. 12 is a disassembled elevational view of another illumination apparatus assembly including another illumination apparatus of the illumination apparatus string of FIG. 1, the lateral portion of FIG. 10, and another lateral portion of the cover apparatus;

FIG. 13 is a cross-sectional view of the illumination apparatus assembly of FIG. 12, taken along the line XIII-XIII in FIG. 1;

FIG. 14 is a cross-sectional view of the illumination apparatus assembly of FIG. 12, taken along the line XIV-XIV in FIG. 1;

FIG. 15 is an elevational view of a cover apparatus according to another illustrative embodiment;

FIG. 16 is an elevational view of a cover apparatus according to another illustrative embodiment;

FIG. 17 is an elevational view of a cover apparatus according to another illustrative embodiment;

FIG. 18 is an elevational view of a cover apparatus according to another illustrative embodiment; and

FIG. 19 is an elevational view of a cover apparatus according to another illustrative embodiment.

### DETAILED DESCRIPTION

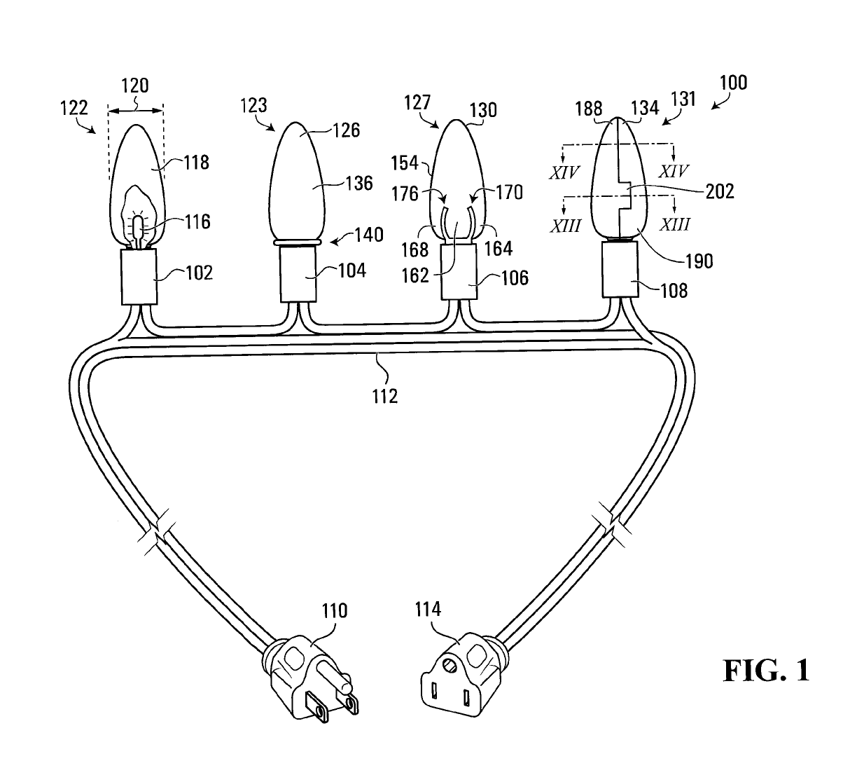

Referring to FIG. 1, an illumination apparatus string according to an illustrative embodiment is shown generally at 100 and includes illumination apparatuses 102, 104, 106, and 108. The illumination apparatus string 100 also includes an alternating-current (“A/C”) electrical plug 110 and a plurality of electrical conductors in an electrical conductors assembly 112. In the embodiment shown, the plurality of electrical conductors in the electrical conductors assembly 112 connect the illumination apparatuses 102, 104, 106, and 108 in a series electrical circuit to the electrical plug 110 and to a stacking plug 114 that can, for example, receive an electrical plug of another illumination apparatus string (not shown) and conduct electric current to the other illumination apparatus string effectively to create a longer illumination apparatus string. However, in alternative embodiments, the illumination apparatuses may be in a parallel electrical circuit or may be in a plurality of different circuits that may be connected to circuitry that causes the illumination apparatuses of the different circuits to illuminate at different times, for example. Also, alternative embodiments may include other circuits such as direct-current (“D/C”) circuits for example, and although four illumination apparatuses 102, 104, 106, and 108 are shown in the embodiment of FIG. 1, alternative embodiments may include more or fewer illumination apparatuses.

Each of the illumination apparatuses 102, 104, 106, and 108 in the embodiment shown includes an LED, such as an LED 116 shown in the illumination apparatus 102. The LEDs in the embodiment shown are white LEDs, namely LEDs that emit white light when conducting electric current. However, the LEDs in alternative embodiments may emit other colours, and alternative embodiments may include more than one LED in each illumination apparatus. Alternative embodiments may also include other types of illumination sources.

In the embodiment shown, each of the illumination apparatuses 102, 104, 106, and 108 includes a refractive cover encapsulating the LED, such as a refractive cover 118 shown in the illumination apparatus 102. The refractive cover 118 is partially broken away in FIG. 1 to show the LED 116 encapsulated in the refractive cover 118. The refractive covers in the embodiment shown are “C6” refractive covers, the “C” denoting a generally candle-like shape and the “6” denoting a maximum diameter or width 120 of about 6/8 inches or about 19 millimeters. However, such refractive covers in alternative embodiments may be one or more of various different sizes and shapes. In general, the refractive cover 118 refracts unidirectional light from the LED 116 to diffuse the light from the LED 116 when electric current passes through the LED 116. The illumination apparatus 102 therefore includes an illuminatable portion shown generally at 122 and including the LED 116 and the refractive cover 118, although illuminatable portions of alternative embodiments may not include refractive covers.

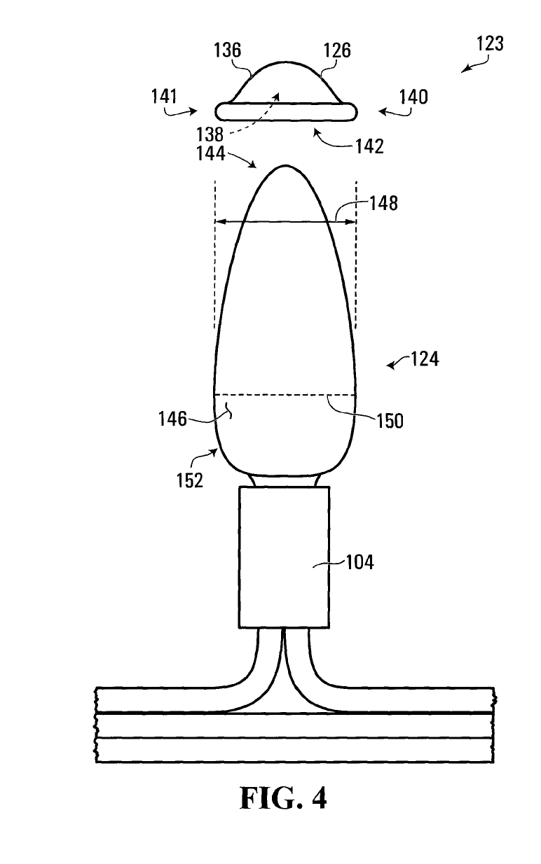

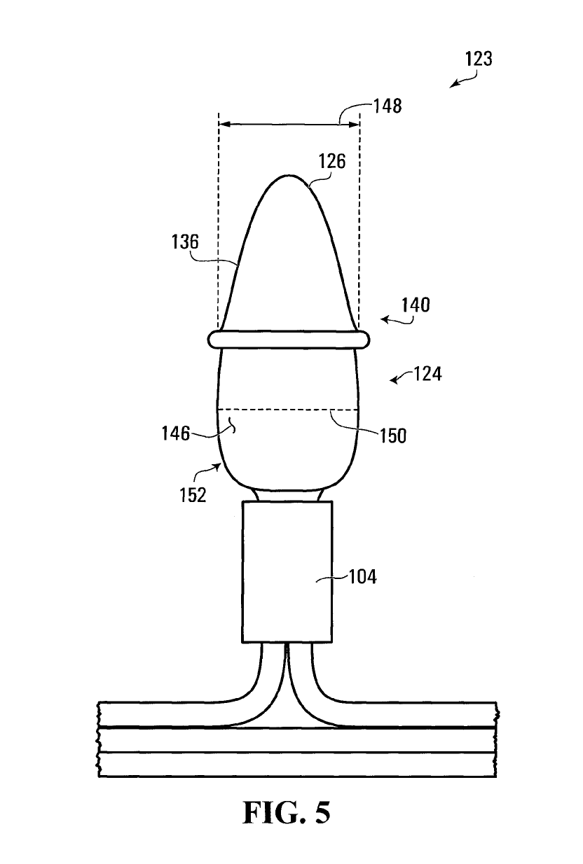

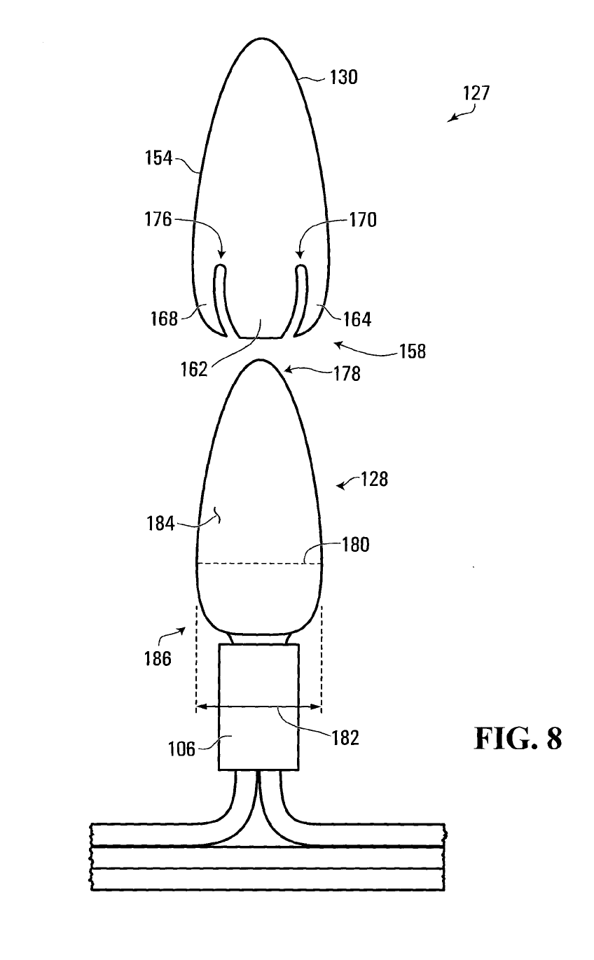

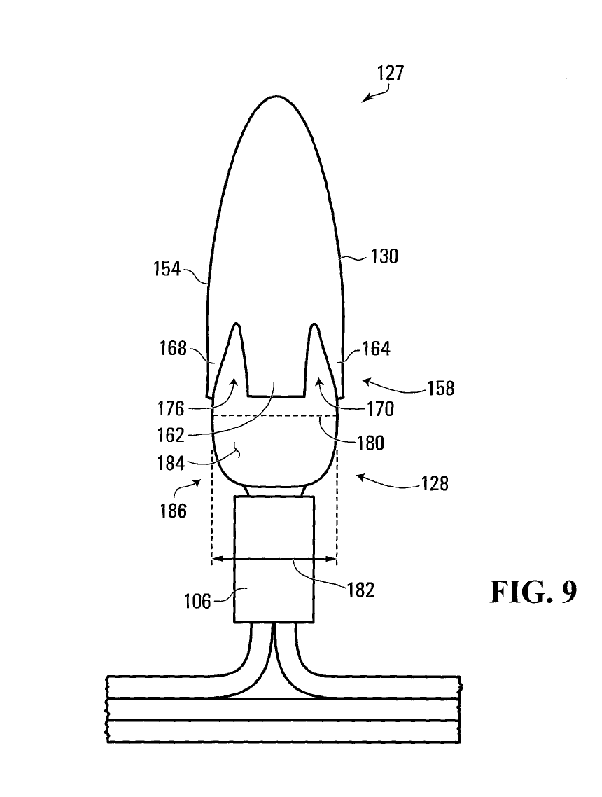

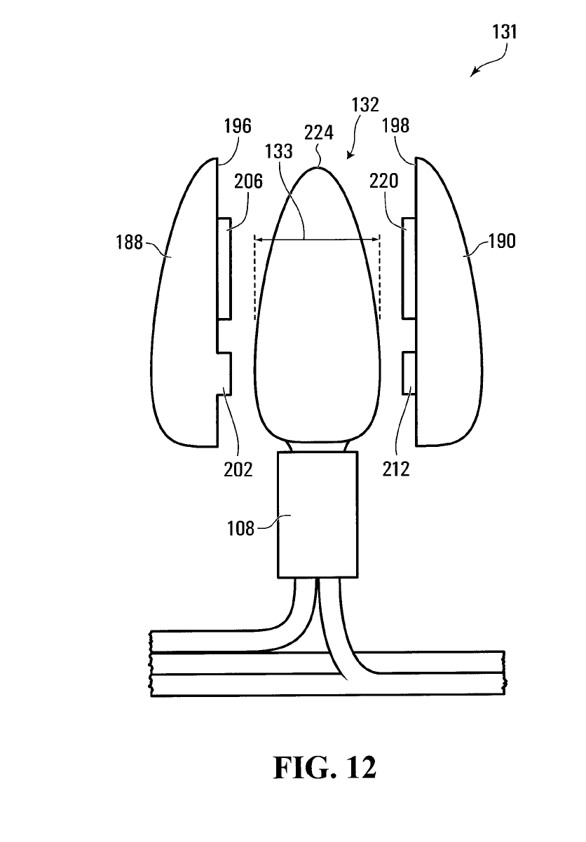

The illumination apparatuses 104, 106, and 108 are substantially the same as the illumination apparatus 102. However, the illumination apparatus 104 includes an illuminatable portion (shown generally at 124 in FIGS. 4 and 5) and is part of an illumination apparatus assembly (shown generally at 123) that includes a cover apparatus 126 on the illuminatable portion 124. Further, the illumination apparatus 106 includes an illuminatable portion (shown generally at 128 in FIGS. 8 and 9) and is part of an illumination apparatus assembly (shown generally at 127) that includes a cover apparatus 130 on the illuminatable portion 128. Still further, the illumination apparatus 108 includes an illuminatable portion (shown generally at 132 in FIG. 12) and is part of an illumination apparatus assembly (shown generally at 131) that includes a cover apparatus 134 on the illuminatable portion 132.

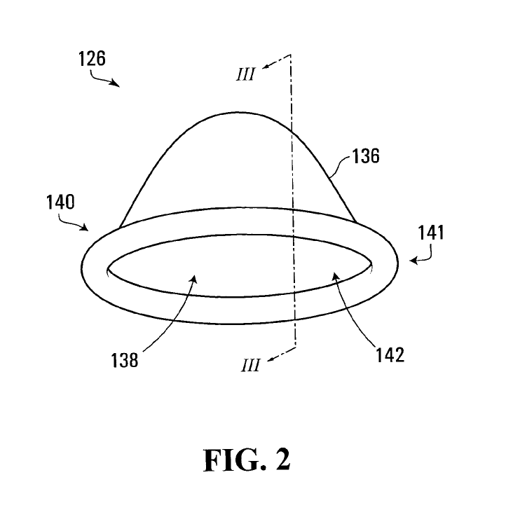

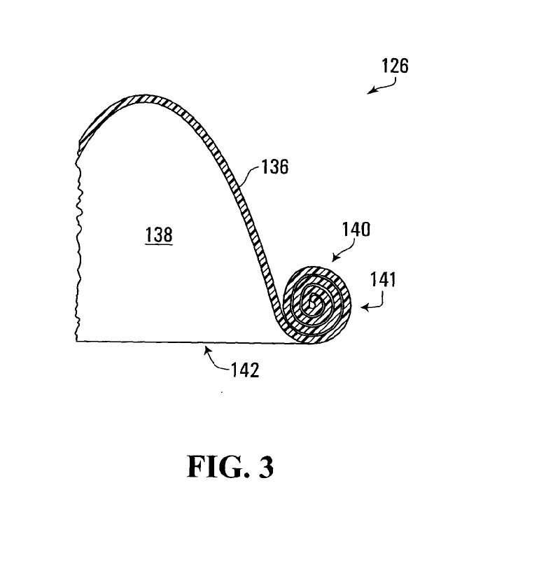

Referring to FIGS. 1 to 4, the cover apparatus 126 includes a resiliently deformable cover body 136 shaped to fit tightly over the illuminatable portion 124 of the illumination apparatus 104 as shown in FIG. 1. The cover body 136 may be unitarily formed from a stretchable material such as latex or another rubber material, for example, although such bodies in alternative embodiments may not be unitary. The cover body 136 defines a receptacle shown generally at 138 to receive at least some of the illuminatable portion 124 of the illumination apparatus 104, and the cover body 136 includes an end portion shown generally at 140. The end portion 140 is adjacent an opening shown generally at 142 to the receptacle 138. As shown in FIGS. 2 and 3, the end portion 140 may be rolled over itself and unrolled like a finger cot. For example, the end portion 140 may be rolled over itself to facilitate storage of the cover body 136, and the end portion 140 may be unrolled to facilitate detachably coupling the cover body 136 to the illumination apparatus 104 as described below. Accordingly, when the end portion 140 is rolled as shown in FIGS. 2 and 3, the end portion 140 includes a rolled portion shown generally at 141.

As shown in FIGS. 4 and 5, the receptacle 138 may receive an apical portion shown generally at 144 of the illuminatable portion 124, and the end portion 140 may be unrolled to extend the cover body 136 over some or all of an outer surface 146 of the illuminatable portion 124. As the end portion 140 is unrolled, the end portion 140 stretches (or, more generally, resiliently deforms) to a width at least as wide as a maximum width 148 of the illuminatable portion 124. In the embodiment shown, when the end portion 140 is unrolled past a circumference 150 of the outer surface 146 having the maximum width 148, the end portion 140 contracts (or, more generally, resiliently deforms) to a width less than the maximum width 148 of the illuminatable portion 124 and contacts a retaining portion shown generally at 152 of the outer surface 146. The retaining portion 152 has a width less than the maximum width 148, and therefore the resilient tendency of the end portion 140 to cause the opening 142 to have a width less than the maximum width 148 facilitates retaining the end portion 140 on the retaining portion 152, and thus the cover body 136 on the illuminatable portion 124. Further, because the cover body 136 is shaped to fit tightly over the illuminatable portion 124, frictional contact between the cover body 136 and the illuminatable portion 124 also facilitates retaining the cover body 136 on the illuminatable portion 124. In various embodiments, one or both of such frictional contact and contact with a retaining portion as described above may facilitate retaining a cover body to an illumination apparatus.

The end portion 140 may also be rolled back on itself, or the cover body 136 may otherwise be removed from the illuminatable portion 124. As such, the cover body 136 may be detachably coupled to the illumination apparatus 102, and more particularly to the illuminatable portion 124 in the embodiment shown. Further, as can be seen from FIGS. 1 to 5, the illuminatable portion 124 is received in the receptacle 138 when the cover body 136 is detachably coupled to the illumination apparatus 102.

Although FIG. 1 illustrates only one cover body 136 for simplicity, other embodiments may include numerous cover bodies similar to the cover body 136 on respective illuminatable portions of a plurality of illumination apparatuses on an illumination apparatus string. In some embodiments, portions of or all of some or all such cover bodies may be transparent, or portions of (or all of) some (or all) such bodies may be coloured with various colours to filter light emitted from an LED (not shown) in the illuminatable portion 124 when electric current passes through the LED and thereby to impart a colour to the light that is transmitted through the cover body 136. Such transparent or coloured portions may generally be referred to as “translucent” portions that permit at least some light from the LED in the illuminatable portion 124 to be transmitted through the cover body.

For example, portions of (or all of) some (or all) such bodies may be coloured with red, green, blue, yellow, or other colours to give the illumination apparatus string an appearance of a traditional string of Christmas lights, or with less-traditional colours such as purple or cyan for example. Alternatively, portions of (or all of) some (or all) such bodies may be coloured with orange for a Halloween decoration, with green for a St. Patrick's Day decoration, with pink for a breast cancer awareness event, or with various other colours or combinations of colours such as one or more colours of a company or brand, for example. Also, some white LEDs may emit a “cool white” (or slightly blue) appearance, and some or all such bodies may be coloured slightly yellow in order to give the LEDs a more “warm white” (or slightly yellow) colour closer to a colour of light from a traditional incandescent bulb. In general, the materials of coloured cover bodies may be selected to allow as much light as possible of desired light wavelengths to pass therethrough while filtering or blocking as much light as possible of undesired wavelengths. In some embodiments in which the bodies are formed of a stretchable material (such as latex or another rubber material for example), such bodies may be coloured by tinting the material from which the bodies are formed.

Still further, portions of (or all of) some (or all) such bodies may be opaque, for example to block light emitted from LEDs that extend on a portion of the illumination apparatus string from a window frame to a power source for the illumination apparatus string, or for LEDs that extend on a portion of the illumination apparatus string that is longer than necessary in a particular location. Further, particular portions of some or all such bodies may be opaque while other portions may be translucent and shaped to project shapes (such as stars or snowflakes, for example) onto nearby surfaces.

Therefore, in summary, detachably coupling a cover body such as the cover body 136 to the illumination apparatus 102 on the illumination apparatus string 100 as described above may change an appearance of the illumination apparatus string 100.

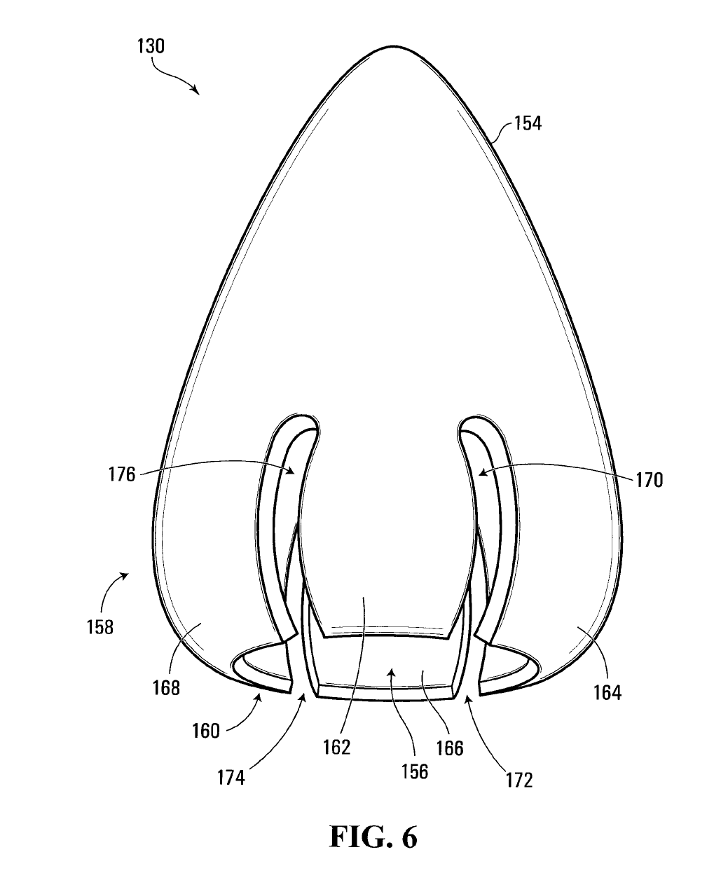

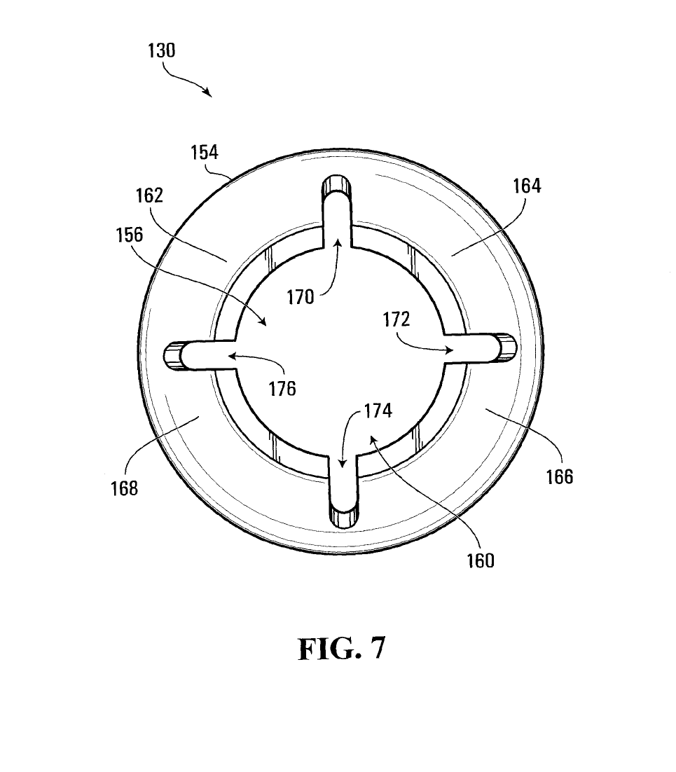

Referring to FIGS. 6 and 7, the cover apparatus 130 (also shown in FIG. 1) includes a cover body 154 shaped to fit over the illuminatable portion 128 (shown in FIGS. 8 and 9) of the illumination apparatus 106 as shown in FIG. 1. In some embodiments, the cover body 154 may be unitarily molded from Lexan™ or another plastic such as another polycarbonate resin thermoplastic, for example, although such bodies in alternative embodiments may not be unitary. Alternative embodiments may include other materials, such as a hardy glass for example. The cover body 154 defines a receptacle shown generally at 156. The receptacle 156 is sized to receive at least some of the illuminatable portion 128 of the illumination apparatus 106, and the cover body 154 includes an end portion shown generally at 158. The end portion 158 is adjacent an opening shown generally at 160 to the receptacle 156. At the end portion 158, the cover body 154 includes projections 162, 164, 166, and 168 surrounding the opening 160 and separated by longitudinal gaps shown generally at 170, 172, 174, and 176. Although the embodiment shown includes four projections 162, 164, 166, and 168 and four longitudinal gaps 170, 172, 174, and 176, alternative embodiments may include more or fewer projections and more or fewer longitudinal gaps.

The end portion 158 of the cover body 154 is resiliently deformable such that the projections 162, 164, 166, and 168 can be resiliently deflected in radial directions from undeflected positions to resiliently deflected positions to widen or narrow the opening 160. For example, referring to FIGS. 8 and 9, the receptacle 156 may receive an apical portion shown generally at 178 of the illuminatable portion 128. The apical portion 178 is tapered and the illuminatable portion 128 widens towards a circumference 180 having a maximum width 182 of an outer surface 184 of the illuminatable portion 128. The projections 162, 164, 166, and 168 may be urged against the apical portion 178 as shown in FIG. 9, and when the projections 162, 164, 166, and 168 are urged against the apical portion 178, the taper of the apical portion 178 facilitates resiliently deflecting one or more of the projections 162, 164, 166, and 168 radially outward to widen one or more of the longitudinal gaps 170, 172, 174, and 176 until the opening 160 (shown in FIGS. 6 and 7) widens resiliently to a width at least as wide as the maximum width 182.

When the opening 160 (shown in FIGS. 6 and 7) is urged past the circumference 180 having the maximum width 182, the projections 162, 164, 166, and 168 resiliently return to, or closer to, the undeflected positions to narrow the opening 160 (shown in FIGS. 6 and 7) to a width less than the maximum width 182 of the illuminatable portion 128. As such, the projections 162, 164, 166, and 168 are retained on a retaining portion shown generally at 186 of the outer surface 184. The retaining portion 186 has a width less than the maximum width 182, and therefore the resilient tendency of the end portion 158 to maintain the opening 160 (shown in FIGS. 6 and 7) to a width less than the maximum width 182 of the illuminatable portion 128 facilitates retaining the cover body 154 on the illuminatable portion 128.

The cover body 154 may be removed from the illuminatable portion 128 by urging the end portion 158 back towards the circumference 180 and thereby widening the opening 160 (shown in FIGS. 6 and 7) again to a width at least as wide as the maximum width 182. As such, the cover body 154 may be detachably coupled to the illumination apparatus 104, and more particularly to the illuminatable portion 128 in the embodiment shown. Further, as can be seen from FIGS. 1 and 6 to 9, the illuminatable portion 128 is received in the receptacle 156 when the cover body 154 is detachably coupled to the illumination apparatus 104.

Again, although FIG. 1 illustrates only one cover body 154 for simplicity, other embodiments may include numerous bodies similar to the cover body 154 on respective illuminatable portions of a plurality of illumination apparatuses on an illumination apparatus string, and in various embodiments, portions of (or all of) some (or all) such bodies may be transparent or coloured with various colours to impart a colour on light emitted from an LED (not shown) in the illuminatable portion 128 when electric current passes through the LED, or portions of (or all of) some (or all) such bodies may be opaque. Therefore, in summary, detachably coupling a cover body such as the cover body 154 to the illumination apparatus 104 on the illumination apparatus string 100 as described above may change an appearance of the illumination apparatus string 100.

In general, such bodies may be coloured by tinting the material from which the bodies are formed, for example by tinting a polycarbonate resin thermoplastic before molding the polycarbonate resin thermoplastic. In some embodiments, such bodies may be coloured by painting one or both of inner and outer surfaces of the bodies. In other embodiments, thin metallic plating on one or both of inner and outer surfaces of the bodies may impart a decorative metallic look to the cover apparatuses.

Referring back to FIG. 1, the cover apparatus 134 includes a cover body having lateral portions 188 and 190. In the embodiment shown, the lateral portion 188 is identical to the lateral portion 190, and the lateral portion 188 may be detachably coupled to the lateral portion 190 as described below. In some embodiments, the lateral portions 188 and 190 may be unitarily molded from Lexan™ or another plastic such as another polycarbonate resin thermoplastic, for example, although such lateral portions in alternative embodiments may not be unitary. Alternative embodiments may include other materials, such as a hardy glass for example.

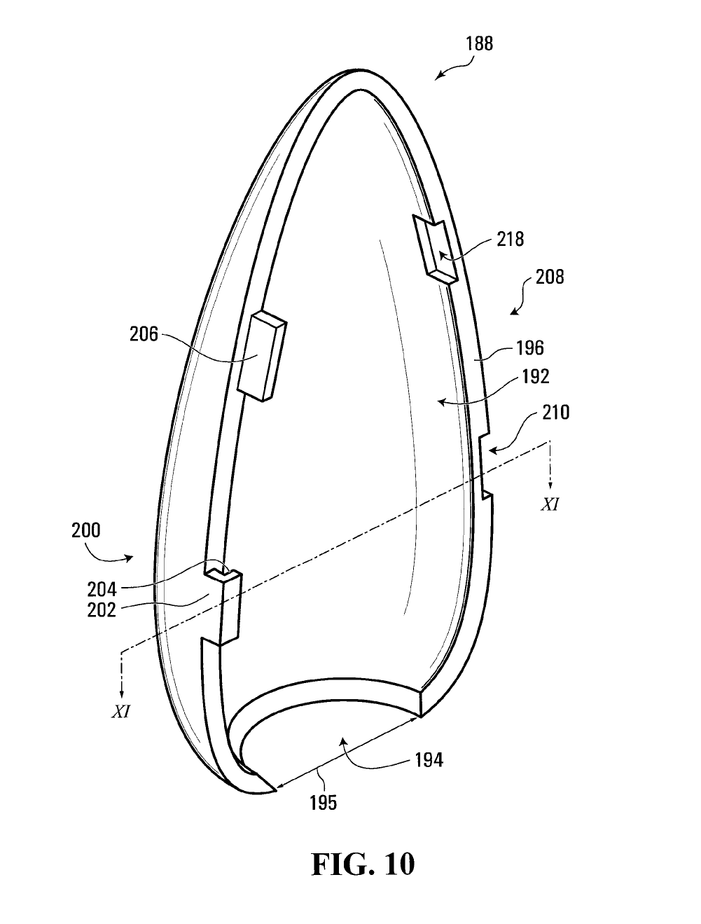

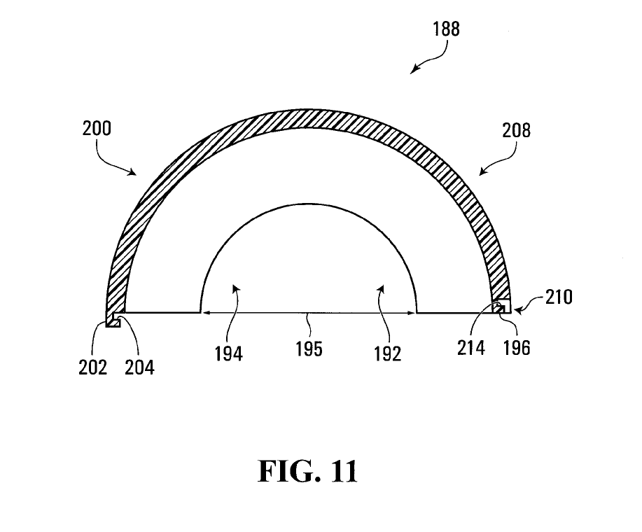

Referring to FIGS. 10, 11, and 12, the lateral portion 188 defines a receptacle shown generally at 192 and shaped to fit over a lateral half or other portion of the illuminatable portion 132 of the illumination apparatus 108 as shown in FIG. 1. The lateral portion 188 also defines a generally semi-circular opening shown generally at 194 to the receptacle 192. The lateral portion 188 also defines an abutment edge 196 that also surrounds an opening to the receptacle 192 and that abuts a corresponding abutment edge 198 of the lateral portion 190 when the lateral portion 188 is detachably coupled to the lateral portion 190 as shown in FIG. 1. On a first side shown generally at 200 of the abutment edge 196, the lateral portion 188 defines a coupling projection 202 projecting away from the abutment edge 196 and having a retaining surface 204 facing towards the abutment edge 196. Also on the first side 200 of the abutment edge 196, the lateral portion 188 defines a coupling projection 206 projecting away from the abutment edge 196 and spaced apart from the coupling projection 202.

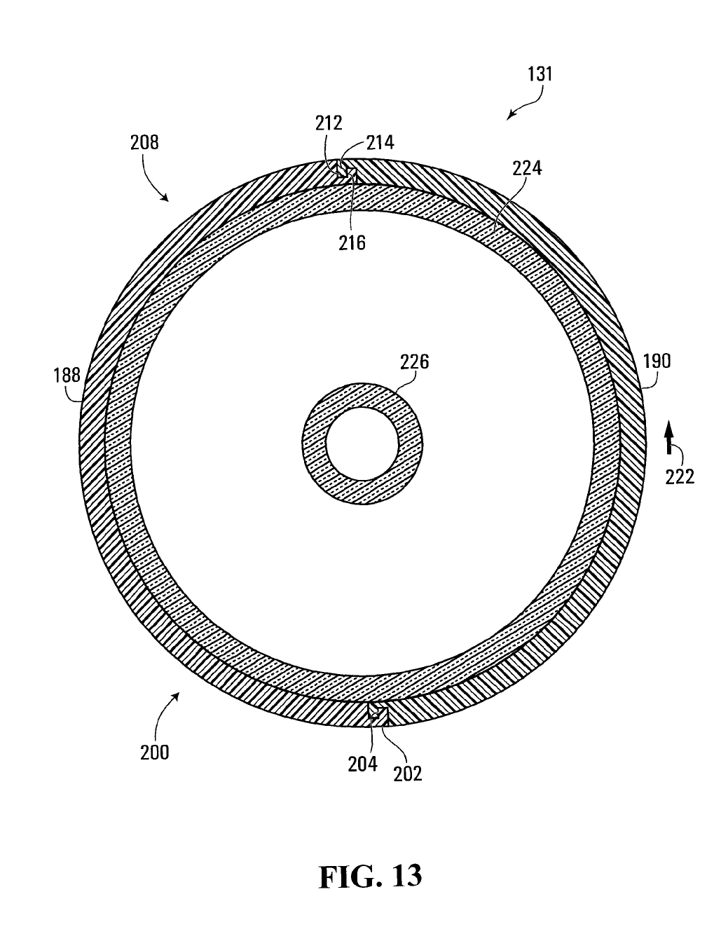

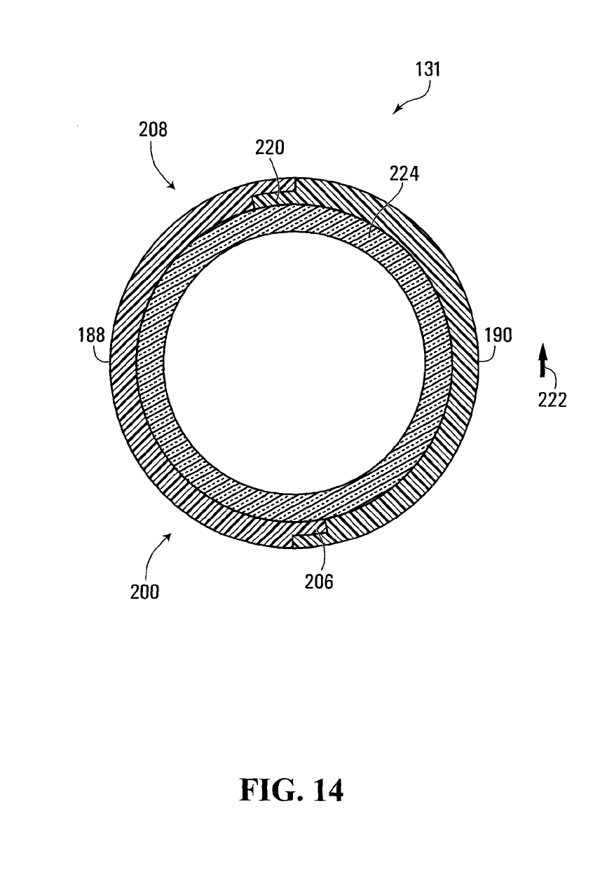

On a second side shown generally at 208 and opposite the first side 200, the lateral portion 188 defines a coupling receptacle shown generally at 210 that is positioned and sized to receive a coupling projection 212 (corresponding to the coupling projection 202) of the lateral portion 190 when the lateral portion 188 is detachably coupled to the lateral portion 190 as shown in FIGS. 1 and 13. Further, the coupling receptacle 210 is adjacent a retaining surface 214 defined by the lateral portion 188, and when the lateral portion 188 is detachably coupled to the lateral portion 190 as shown in FIGS. 1 and 13, the retaining surface 214 contacts a retaining surface 216 (corresponding to the retaining surface 204) on the coupling projection 212 to retain the abutment edge 196 against the abutment edge 198 and to retain the lateral portion 188 detachably coupled to the lateral portion 190. Still further, on the second side 208, the lateral portion 188 defines a coupling receptacle shown generally at 218 that is positioned and sized to receive a coupling projection 220 (corresponding to the coupling projection 206) of the lateral portion 190 when the lateral portion 188 is detachably coupled to the lateral portion 190 as shown in FIGS. 1 and 14.

In the embodiment shown, the lateral portions 188 and 190 are resiliently deformable such that one or both of the lateral portions 188 and 190 may be resiliently deformed to allow the coupling projection 212 to be received in the coupling receptacle 210 with the retaining surface 204 and 216 in contact, and to allow the coupling projection 202 to be received in a coupling receptacle (not shown) of the lateral portion 190 corresponding to the coupling receptacle 210, to retain the lateral portion 188 detachably coupled to the lateral portion 190. Further, in the embodiment shown, the lateral portions 188 and 190 are resiliently deformable such that one or both of the lateral portions 188 and 190 may be resiliently deformed to remove the coupling projections 202 and 212 from their respective coupling receptacles to detach the lateral portion 188 from the lateral portion 190.

As shown in FIG. 13, the coupling projections 202 and 212, on their own, may not prevent separation of the lateral portion 190 from the lateral portion 188 because, for example, movement of the lateral portion 190 relative to the lateral portion 188 in the direction of the arrow 222 could separate the lateral portions 188 and 190. However, as shown in FIG. 14, the coupling projection 206 contacts a surface in a coupling receptacle (not shown) in the lateral portion 190 (corresponding to the coupling receptacle 218), and the coupling projection 220 contacts a surface in the coupling receptacle 218 to prevent movement of the lateral portion 190 relative to the lateral portion 188 in the direction of the arrow 222. FIGS. 13 and 14 also illustrate a refractive cover 224 encapsulating an LED 226 in the illumination apparatus 108.

In summary, the coupling projections 202 and 212 and the coupling projections 206 and 220 cooperate with the various receptacles described above to facilitate detachably coupling the lateral portions 188 and 190. Further, as can be seen from FIGS. 1 and 10 to 14, when the lateral portion 188 is detachably coupled to the lateral portion 190, the receptacle 192 and a corresponding receptacle (not shown) of the lateral portion 190 define a combined receptacle sized to receive the illuminatable portion 132. Still further, the generally semi-circular opening 194 has a width 195 that is less than a maximum width 133 (shown in FIG. 12) of the illuminatable portion 132, and therefore when the lateral portion 188 is detachably coupled to the lateral portion 190, the cover body including the lateral portions 188 and 190 may be detachably coupled to the illumination apparatus 108, and more particularly to the illuminatable portion 132 in the embodiment shown, with the illuminatable portion 132 received in the combined receptacle when the cover body including the lateral portions 188 and 190 is detachably coupled to the illumination apparatus 108.

Again, although FIG. 1 illustrates only one cover body including the lateral portions 188 and 190 for simplicity, other embodiments may include numerous such bodies on respective illuminatable portions of a plurality of illumination apparatuses on an illumination apparatus string, and in various embodiments, portions of or all of some such lateral portions may be transparent or coloured (for example, by tinting, painting, or metallic plating as described above) with various colours to impart a colour on light emitted from the LED 226 in the illuminatable portion 128 when electric current passes through the LED, or portions of or all of some such lateral portions may be opaque. Also, in some embodiments, the lateral portions of a cover body on an illuminatable portion of an illumination apparatus may have different colours to impart a multi-colour appearance to the particular illumination apparatus. However, in alternative embodiments, lateral portions of a cover body of a cover apparatus may not be identical. Also, lateral portions according to alternative embodiments may be detachably coupled to each other using structures or materials that may differ from the coupling projections and coupling receptacles described above. For example, lateral portions according to alternative embodiments may be detachably coupled to each other using pins on one or more of the lateral portions that may be each received in a friction fit on an opposite lateral portion to detachably couple the lateral portions, and in such embodiments, resiliently deforming the lateral portions may be unnecessary.

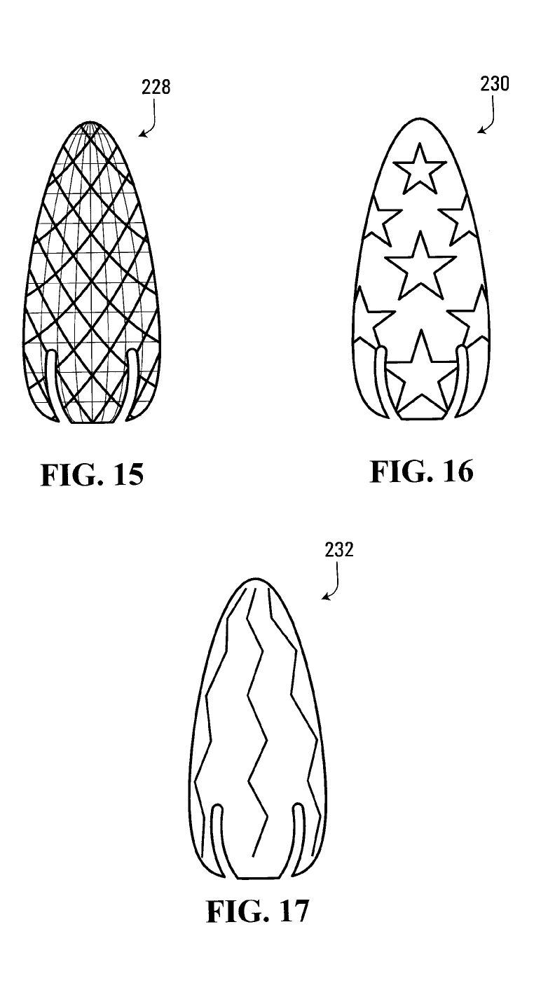

In alternative embodiments, cover apparatuses for illuminatable portions of illumination apparatuses may include cover bodies having various shapes, patterns, and other appearances. For example, FIG. 15 illustrates a cover apparatus shown generally at 228 and including a cover body that may be detachably coupled to an illuminatable portion of an illumination apparatus in a similar manner to the cover apparatus 130 (shown in FIGS. 1 and 6 to 9), but that includes a surface treatment (which may include etching, adhesives, or paint, for example) to cause diamond shapes to appear on the cover apparatus 228. Also, FIG. 16 illustrates a cover apparatus shown generally at 230 and including a cover body that may be detachably coupled to an illuminatable portion of an illumination apparatus in a similar manner to the cover apparatus 130, but that includes a surface treatment to cause star shapes to appear on the cover apparatus 230. Further, FIG. 17 illustrates a cover apparatus shown generally at 232 and including a cover body that may be detachably coupled to an illuminatable portion of an illumination apparatus in a similar manner to the cover apparatus 130, but that includes a surface treatment to cause zig-zag shapes to appear on the cover apparatus 232. Cover bodies of still other alternative embodiments may cause still other shapes to appear, such as prisms, spirals, stars, or other shapes that affect refraction of light through the cover bodies such that light refracted through the cover bodies will have different appearances from different positions relative to the cover bodies.

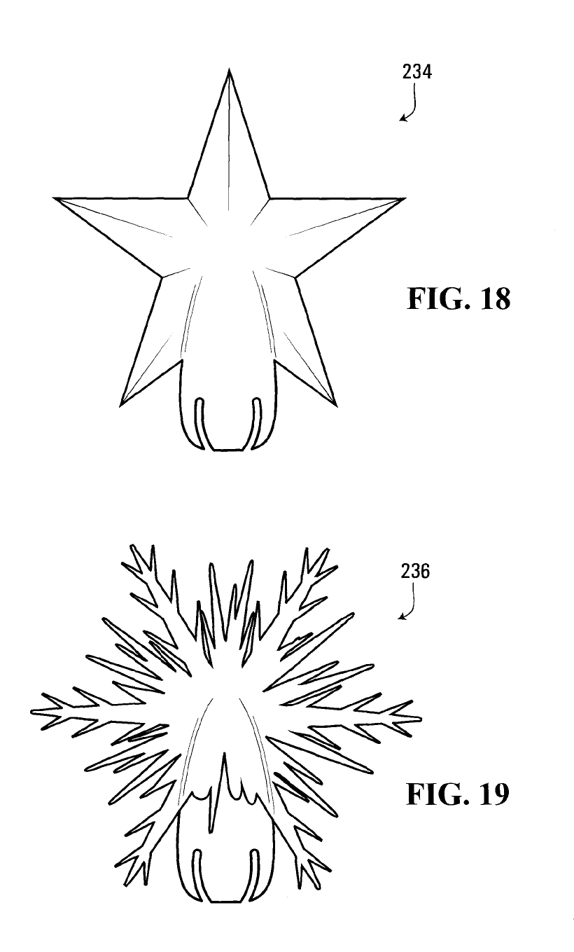

Also, FIG. 18 illustrates a cover apparatus shown generally at 234 and including a cover body that may be detachably coupled to an illuminatable portion of an illumination apparatus in a similar manner to the cover apparatus 130, but that includes an outer surface in a star shape, and FIG. 19 illustrates a cover apparatus shown generally at 236 and including a cover body that may be detachably coupled to an illuminatable portion of an illumination apparatus in a similar manner to the cover apparatus 130, but that includes an outer surface in a snowflake shape. Cover bodies of still other alternative embodiments may include various other shapes and appearances, such as a larger outer surface to make the illuminatable portion of an illumination apparatus appear larger, or outer surfaces with appearances of cartoon characters, for example.

Although the cover apparatuses 228, 230, 232, 234, and 236 include bodies that may be detachably coupled to an illuminatable portion of an illumination apparatus in a similar manner to the cover apparatus 130, still further alternative embodiments may include cover bodies including surface treatments or outer surface shapes such as those of the cover apparatuses 228, 230, 232, 234, and 236 but that include lateral portions that may be detachably coupled to an illuminatable portion of an illumination apparatus in a similar manner to the cover apparatus 134, for example. In such embodiments, the lateral portions of the cover body may not be identical. For example, if the cover body has an outer surface in a star shape, then the lateral portions of the cover body may be identical, but if the cover body has an outer surface in a skull shape, then the lateral portions of the cover body may not be identical.

Commercial embodiments may include kits including one or more of the cover apparatuses described above and may offered commercially for use in changing an appearance of one or more illumination apparatus strings, such as for occasions including Christmas, Halloween, St. Patrick's Day, breast cancer awareness events, and other occasions to decorate, for example, inside or outside of homes, inside or outside of other residential or commercial buildings, or landscaping such as trees or bushes. Such cover apparatuses may include cover bodies sized and configured to be detachably coupled to various sizes and shapes of illumination apparatuses. For example, although the embodiments described above include “C6” refractive covers having a generally candle-like shape, illumination apparatuses according to other embodiments may have different shapes that may not include wider middle portions such as at the circumferences 150 and 180 in the embodiments shown in FIGS. 4, 5, 8, and 9. Cover apparatuses of such alternative embodiments may, for example, include cover bodies configured to be detachably coupled to illumination apparatuses using retaining portions that differ from the 152 and 186 in the embodiments shown in FIGS. 4, 5, 8, and 9, or cover bodies configured to be detachably coupled to illumination apparatuses by friction alone. Also, such kits may include one or more illumination apparatus strings, which may include LEDs or other illumination sources. In general, cover apparatuses, assemblies, and kits such as those described above may allow some potential advantages LED strings or strings with other illumination sources (such as lower energy use, lower heat emission, and greater longevity for example) and with greater adaptability than is available from such strings that otherwise have a generally uniform and constant appearance. In other words, cover apparatuses, assemblies, and kits such as those described above may allow flexibility to change appearance of an illumination apparatus string similar to flexibility available with strings of incandescent light bulbs, but with potential advantages of other types of lights.

Although specific embodiments have been described and illustrated, such embodiments should be considered illustrative only and not as limiting the invention as construed according to the accompanying claims.

1. A method of changing an appearance of an illumination apparatus string, the method comprising:
detachably coupling a cover body to one of a plurality of illumination apparatuses on the illumination apparatus string such that an illuminatable portion of the one of the plurality of illumination apparatuses is received in a receptacle defined by the cover body.

2. The method of claim 1 wherein the illuminatable portion of the one of the plurality of illumination apparatuses comprises a light-emitting diode (“LED”).

3-7. (canceled)

8. The method of claim 1 wherein detachably coupling the cover body to the one of the plurality of illumination apparatuses comprises resiliently deforming an end portion of the cover body adjacent an opening to the receptacle to widen the opening to the receptacle resiliently to a width at least as wide as a maximum width of the illuminatable portion of the one of the illumination apparatuses.

9. The method of claim 8 wherein resiliently deforming the end portion of the cover body comprises causing the end portion of the cover body to be retained on a retaining portion of an outer surface of the illuminatable portion of the one of the illumination apparatuses, the retaining portion having a width less than the maximum width of the illuminatable portion of the one of the illumination apparatuses.

10. (canceled)

11. The method of claim 1 wherein detachably coupling the cover body to the one of the plurality of illumination apparatuses comprises unrolling a rolled portion of the cover body.

12-15. (canceled)

16. A cover apparatus comprising:
a cover body defining a receptacle and configured to be detachably coupled to one of a plurality of illumination apparatuses on an illumination apparatus string such that an illuminatable portion of the one of the illumination apparatuses is received in the receptacle when the cover body is detachably coupled to the one of the illumination apparatuses.

17. The apparatus of claim 16 wherein the illuminatable portion of the one of the plurality of illumination apparatuses comprises a light-emitting diode (“LED”).

18. The method of claim 16 wherein the cover body is configured to be detachably coupled to a refractive cover of the illuminatable portion of the one of the plurality of illumination apparatuses.

19. The apparatus of claim 16 wherein the cover body comprises an opaque portion positioned to block light emitted from the illuminatable portion of the one of the illumination apparatuses when the illuminatable portion of the one of the illumination apparatuses is received in the receptacle.

20. The apparatus of claim 16 wherein the cover body comprises a translucent portion positioned to transmit at least some light emitted from the illuminatable portion of the one of the illumination apparatuses when the illuminatable portion of the one of the illumination apparatuses is received in the receptacle.

21. The apparatus of claim 16 wherein the cover body comprises:
at least one opaque portion positioned to block light emitted from the illuminatable portion of the one of the illumination apparatuses when the illuminatable portion of the one of the illumination apparatuses is received in the receptacle; and
at least one translucent portion positioned to transmit at least some of the light emitted from the illuminatable portion of the one of the illumination apparatuses when the illuminatable portion of the one of the illumination apparatuses is received in the receptacle.

22. The apparatus of claim 16 wherein at least a portion of the cover body is resiliently deformable to facilitate detachably coupling the cover body to the one of the plurality of illumination apparatuses.

23. The apparatus of claim 22 wherein the cover body defines an opening to the receptacle, the cover body comprises an end portion adjacent the opening to the receptacle, and the end portion is resiliently deformable to widen the opening to the receptacle resiliently to a width at least as wide as a maximum width of the illuminatable portion of the one of the illumination apparatuses.

24. The apparatus of claim 23 wherein the end portion of the cover body is configured to be retained on a retaining portion of an outer surface of the illuminatable portion of the one of the illumination apparatuses, the retaining surface having a width less than the maximum width of the illuminatable portion of the one of the illumination apparatuses.

25. The apparatus of claim 23 wherein the end portion of the cover body is stretchable to the width at least as wide as the maximum width of the illuminatable portion of the one of the illumination apparatuses.

26. The apparatus of claim 16 wherein a portion of the cover body is configured to be unrolled to facilitate detachably coupling the cover body to the one of the plurality of illumination apparatuses.

27. The apparatus of claim 23 wherein the end portion of the cover body comprises a plurality of projections surrounding the opening to the receptacle, the plurality of projections being resiliently deflectable to widen the opening to the receptacle resiliently to the width at least as wide as the maximum width of the illuminatable portion of the one of the illumination apparatuses.

28. The apparatus of claim 16 wherein the cover body is unitary.

29. The apparatus of claim 16 wherein the cover body comprises first and second lateral portions, the first lateral portion of the cover body configured to be detachably coupled to the second lateral portion of the cover body to couple the cover body detachably to the one of the plurality of illumination apparatuses.

30. The apparatus of claim 29 wherein the first lateral portion of the cover body defines a first retaining surface, the second lateral portion of the cover body defines a second retaining surface, and at least a portion of at least one of the first and second lateral portions of the cover body is configured to be resiliently deformed to position the first retaining surface in contact with the second retaining surface to couple the first lateral portion of the cover body detachably to the second lateral portion of the cover body.

31-35. (canceled)
